(19) United States
(12) Patent Application Publication
(10) Pub. No.: US 2024/0407584 A1
(43) Pub. Date: Dec. 12, 2024

(54) Lid Assembly And Multifunctional Cooking Utensil

(71) Applicant: Zhejiang Shaoxing Supor Domestic Electrical Appliance Co. Ltd, Shaoxing, Zhejiang (CN)

(72) Inventors: Fei Xu, Shaoxing, Zhejiang (CN); Xuzhong Ouyang, Shaoxing, Zhejiang (CN)

(73) Assignee: Zhejiang Shaoxing Supor Domestic Electrical Appliance Co. Ltd, Shaoxing, Zhejiang (CN)

(21) Appl. No.: 18/721,450

(22) PCT Filed: Sep. 21, 2022
(86) PCT No.: PCT/CN2022/120300

§ 371 Date: Jun. 18, 2024

(30) Foreign Application Priority Data
Dec. 23, 2021 (CN) 202111589569.2
Dec. 23, 2021 (CN) 202123264535.4
Apr. 20, 2022 (CN) 202210416736.1
Apr. 20, 2022 (CN) 202220918150.0

(51) Int. Cl. A47J 27/086; A47J 27/08; A47J 27/092; A47J 37/06

(52) U.S. Cl. CPC A47J 27/086; A47J 27/0804; A47J 27/092; A47J 37/0641

(57) ABSTRACT

A lid assembly for multifunctional cooking utensil comprising a utensil lid capable of covering the utensil and comprising an inner lid having an upper wall and a cavity defined partially by the upper wall, a face lid covering the inner lid, and a hot air assembly in the cavity. It further comprises a cooking mode switching device and an air frying valve provided at the upper wall of the inner lid, an air frying valve position limiter being provided between the device and the valve. When the device is in a first state, a first end of the limiter limits the valve to a first position in which an airtight engagement is formed between the valve and the upper wall of the inner lid. When the device is in a second state, the valve is released from the limitation of the first end and can, under the effect of its own weight, switch to a second position in which a passage for air circulation is formed between the valve and the upper wall of the inner lid.

### FIELD

The present application relates to the field of kitchen home appliances, and in particular to a lid assembly for multifunctional cooking utensil and a multifunctional cooking utensil comprising such a lid assembly.

### BACKGROUND

Currently, in order to be user friendly and reduce occupied space in a kitchen, cooking utensils that integrate multiple functions have emerged in the market, in particular, multifunctional cooking utensils that combine a function of air fryer/baking and a function of pressure cooking.

This type of cooking utensil can essentially be classified into two categories: one category consists of cooking utensils with multiple lids, where a user achieves different cooking functions by selecting different lids; the other category consists of cooking utensils equipped with only one lid, which lid can switch between different cooking modes so that different cooking functions can be achieved without changing the lid.

Obviously, the former category of cooking utensils is not convenient for a user to use, occupies a relatively large space, and has a relatively high cost. As to the latter category, for example in the multiple functional cooking utensil disclosed in the Chinese patents CN214548988U and CN214548823U, the switching between different cooking modes is achieved by the movement in different directions of a transmission rod connected to an air gate provided at an outer side of an air guide, which rod is pushed by a transmission block provided on a lock ring. More specifically, when the transmission block pushes the transmission rod to an air frying/baking mode, the seal block located at the inner side of the air guide is pushed away so that the cooking chamber becomes in communication with exterior atmosphere; when the transmission block pushes the transmission rod to a pressure cooking mode, the sealing block sealingly engages with the inner side of the air guide so that a sealed cooking chamber is formed inside the utensil. However, such a technical solution has in particular the following drawbacks: when there is a pressure inside the utensil, the transmission rod cannot be pushed, and if it is pushed by force, on one hand, damage to relevant parts will be caused, and on the other hand, there is a safety risk; the mode switching device of this utensil is of a complicated structure and has a high cost; after the sealing block has switched between the pressure cooking mode and the air frying/baking mode multiple times, the sealing ring on the sealing block is easily damaged and air leakage occurs.

Therefore, an improved multifunctional cooking utensil needs to be provided.

### SUMMARY

An objective of the present application is to provide a lid assembly for a multifunctional cooking utensil that is of a simple and stable structure, convenient to operate, and safe and reliable, and a multifunctional cooking utensil comprising such a lid assembly, wherein the lid assembly can help the cooking utensil achieve an air frying/baking function and a pressure cooking function.

According to an aspect of the present application, a lid assembly for a multifunctional cooking utensil is provided, comprising a utensil lid capable of covering the cooking utensil, the utensil lid comprising: an inner lid having an upper wall and a cavity defined partially by the upper wall; a face lid covering the inner lid; and, a hot air assembly located in the cavity inside the inner lid. The lid assembly further comprises a cooking mode switching device and an air frying valve provided at the upper wall of the inner lid, wherein an air frying valve position limiter is provided between the cooking mode switching device and the air frying valve. When the cooking mode switching device is in a first state, a first end of the air frying valve position limiter limits the air frying valve to a first position in which an airtight engagement is formed between the air frying valve and the upper wall of the inner lid. When the cooking mode switching device is in a second state, the air frying valve is released from the limitation of the first end and can, under the effect of its own weight, switch to a second position in which a passage for air circulation is formed between the air frying valve and the upper wall of the inner lid. A cooking utensil equipped with such a lid assembly has both an air frying/baking function and a pressure cooking function, and by simply operating the cooking mode switching device, the state of the air frying valve can be controlled and thus communication at the air frying valve between the cooking chamber and the atmosphere can be modified so as to easily achieve switching between different cooking modes. In addition, the mechanism for achieving such switching is of a simple and stable structure, safe and reliable, has a lower cost, and a longer life.

According to some modes of realization of the present application, the cooking mode switching device has a ball-point-pen-style telescopic structure comprising a button located at an upper end and a tip located at a lower end, the button extending upward through the face lid so that it can be accessed by a user; when the button is not pressed and the tip is in a retracted position, the cooking mode switching device is in the first state; and, when the button is pressed and the tip is in an extended position, the cooking mode switching device is in the second state. A ball-point-style telescopic structure is technically mature, easy to manufacture, and stable and reliable, and a user need only simply press the button to easily cause the cooking mode switching device to switch between the first state and the second state and thus cause a cooking utensil equipped with such a lid assembly to easily switch between an air frying/baking mode and a pressure cooking mode.

According to some modes of realization of the present application, the cooking mode switching device is a rod fixed to a second end of the air frying valve position limiter and extending through the face lid to be accessible by a user, the rod being moveable between two positions corresponding to the first state and the second state respectively. The rod is simple in structure and easy to manufacture. Users can easily switch between the first state and the second state by simply moving the rod, thereby enabling the cooking utensil equipped with the lid assembly to easily switch between the air frying/baking mode and the pressure cooking mode.

According to some modes of realization of the present application, the air frying valve comprises a head and a body that has an external radial size smaller than that of the head and is fixed the head, the head and the body having an axial fluid passage in communication with each other; and the first end of the air frying valve position limiter is a U-shaped structure extending substantially in a horizontal direction, two sides of the U-shaped structure each being provided on its upper surface with a slope-shaped structure, a lower surface of the head of the air frying valve being supported on the slope-shaped structure while the body of the air frying valve being slidably arranged in a slot between the two sides of the U-shaped structure. As the name implies, the slope-shaped structure has different heights at different locations. The closer it is to the air frying valve, the smaller the height is. In this way, when the air frying valve is located at the end with the maximum height of the slope-shaped structure, the air frying valve is lifted to form a sealed engagement with the upper wall of the inner lid. When the air frying valve is located at the end with the minimum height of the slope-shaped structure, the air frying valve loses its support and can drop to the second position under its own gravity, so that a fluid communication between the internal cavity and the axial fluid passage inside the air frying valve can be achieved.

According to some modes of realization of the present application, the body of the air frying valve is provided at a lower end with a sealing ring and a radial through hole located above the sealing ring; when the air frying valve is in the first position, an airtight engagement is formed between the sealing ring and the upper wall of the inner lid; and, when the air frying valve is in the second position, the cavity inside the inner lid is in fluid communication with the axial fluid passage via the radial through hole. By providing the above described sealing ring and radial through hole, communication at the air frying valve between the cooking chamber and the atmosphere can be easily and reliably modified based on the position of the air frying valve in a vertical direction (at a higher first position or a lower second position).

According to some modes of realization of the present application, the hot air assembly comprises a first fan driven by a motor and a first heating element provided below the first fan. The first heating element can heat surrounding air, and the first fan can blow heated air towards food to be cooked placed in an inner pot, ensuring that a desired cooking result is obtained under an air frying/baking mode.

According to some modes of realization of the present application, the lid assembly further comprises an L-shaped arm coupled to the utensil lid, the arm comprising a horizontal part extending substantially in a horizontal direction and a vertical part extending substantially in a vertical direction, the motor being located in the horizontal part. Thus, the motor and associated electrical elements are separately located inside the horizontal part of the arm and not susceptible to damage caused by interference of other parts, which also facilitates maintenance and repair. In addition, as most electrical elements are not located in the utensil lid, after the utensil lid is removed, it can be conveniently cleaned.

According to some modes of realization of the present application, the lid assembly further comprises a second fan located between the upper wall of the inner lid and the face lid, the second fan being driven by the motor. The second fan can dissipate heat from the space between an upper wall of the inner lid and the face lid, preventing the utensil lid from being overheated while preventing excessive heat from being transmitted to the motor to affect its service life.

According to some modes of realization of the present application, the lid assembly further comprises a protective cover located below the first heating element. The protective cover allows to prevent grease, smoke, etc. in an inner pot from polluting the hot air assembly so as to extend its service life.

According to some modes of realization of the present application, the lid assembly further comprises a sensor located in the proximity of the air frying valve position limiter and used for sensing its position. The sensor can send different signals to a controller of the cooking utensil based on the position of the air frying valve position limiter, and the controller commands a display screen of the cooking utensil to display different information, for example, a menu prompt corresponding to the currently selected cooking mode, based on the signals received.

According to some modes of realization of the present application, the lid assembly further comprises a pressure relief valve and a lever provided at the upper wall of the inner lid, the lever comprising a first end in contact with the pressure relief valve and a second end opposite the first end; when the cooking mode switching device is in the first state, the pressure relief valve is in a third position in which an airtight engagement is formed between the pressure relief valve and the upper wall of the inner lid; and, when the cooking mode switching device is in the second state, the first end of the lever is pressed down so that, under the effect of a second end of the lever, the pressure relief valve switches to a fourth position in which a passage for air circulation is formed between the pressure relief valve and the upper wall of the inner lid. By providing the pressure relief valve, pressure can be released automatically in the event that the air pressure inside the cooking utensil is too high, improving utilization safety. In addition, as the pressure relief valve is indirectly connected to the cooking mode switching device via the lever, the states of the air frying valve and the pressure relief valve can be controlled at the same time by operating only the cooking mode switching device, which facilitates switching between different cooking modes. In addition, when a user desires to switch directly from a pressure cooking mode to an air frying/baking mode and thus operates the cooking mode switching device, but the air frying valve cannot drop to a lower second position under the effect of its weight, to achieve the communication between the cooking chamber and the atmosphere due to a relatively high air pressure inside the cooking utensil, the valve body of the pressure relief valve is lifted under the effect of the lever that is linked in motion with the cooking mode switching device to achieve venting for pressure relief (i.e. exhaust mode). When the pressure drops to a certain degree, the air frying valve drops to a low position, so that the cooking chamber is also in communication with the atmosphere at the air frying valve to enter the air frying/baking mode. Venting at two locations (i.e., at the air frying valve and at the pressure relief valve) can better meet venting requirements under an air frying/baking mode.

According to some modes of realization of the present application, the lever is arranged between the air frying valve position limiter and the pressure relief valve. When the cooking mode switching device is in the second state, the first end of the lever is pressed down by the first end of the air frying valve position limiter.

According to some modes of realization of the present application, the lid assembly further comprises a C-shaped member extending circumferentially along an edge of the upper wall of the inner lid, the air frying valve position limiter being formed by a first end of the C-shaped member, and the lever being arranged between a second end of the C-shaped member and the pressure relief valve. When the cooking mode switching device is in the second state, the first end of the lever is pressed down by the second end of the C-shaped member.

According to some modes of realization of the present application, the pressure relief valve comprises a valve body and a valve spool provided inside the valve body; when the pressure relief valve is in the third position, the valve spool forms an airtight engagement with an outlet of a venting passage of a venting conduit inserted vertically in the upper wall of the inner lid; when the pressure relief valve is in the fourth position, the valve spool disengages from the outlet so that the cavity inside the inner lid is in communication with exterior atmosphere. The above described structure of the pressure relief valve is simple, reliable, and easy to manufacture.

According to some modes of realization of the present application, the lever comprises a first section and a second section both extending substantially in a horizontal direction, and a middle section connecting the first section and the second section and provided with a fulcrum, the first section comprising the first end of the lever, the second section comprising the second end of the lever; the first end of the lever abuts against a lower surface of the first end of the air frying valve position limiter, and the second end of the lever abuts against a lower surface of the valve body of the pressure relief valve. As the first end and the second end of the lever both extend substantially in a horizontal direction, they can better fit the surfaces against which they respectively abut, achieving accurate and stable transmission of motion.

According to some modes of realization of the present application, the lever comprises a first section and a second section both extending substantially in a horizontal direction, and a middle section connecting the first section and the second section and provided with a fulcrum, the first section comprising the first end of the lever, the second section comprising the second end of the lever. The first end of the lever abuts against a lower surface of the second end of the C-shaped member, and the second end of the lever abuts against a lower surface of the valve body of the pressure relief valve.

According to some modes of realization of the present application, the lower surface of the second end of the C-shaped member further comprises a boss. When the boss comes into contact with the first end of the lever, it can effectively press the latter to make the second end of the lever rise and lift the pressure relief valve to the fourth position. Those skilled in the art can control the degree and timing of pressing the lever by adjusting the position, shape and height of the boss according to actual needs.

According to another aspect of the present application, a multifunctional cooking utensil is provided, comprising a utensil body and a lid assembly as described above capable of sealingly covering the utensil body. The cooking utensil can easily achieve an air frying/baking function and a pressure cooking function without changing the lid. Of course, the cooking utensil can also be equipped with a lid assembly used for achieving another cooking function.

According to some modes of realization of the present application, the lid assembly is pivotably hinged to the utensil body and moveable between an open position and a closed position.

According to some modes of realization of the present application, the multifunctional cooking utensil further comprises a second heating element located inside a base of the utensil body. The second heating element is used for heating food accommodated in an inner pot from its bottom, and can be used separately or at the same time with the first heating element located inside the lid assembly based on a user's desire to achieve different cooking results.

According to some modes of realization of the present application, in the event that the lid assembly sealingly covers the utensil body, when the cooking mode switching device is in the first state, a sealed cooking chamber is formed between the lid assembly and the utensil body, at which time food inside the cooking chamber can be pressured cooked; when the cooking mode switching device is in the second state, the cooking chamber between the lid assembly and the utensil body is in communication with exterior atmosphere, at which time food inside the cooking chamber can be baked or air fried. Thus, the switching between different cooking modes can be achieved simply by modifying the state of the mode switching device.

According to some modes of realization of the present application, the multifunctional cooking utensil further comprises a controller, a human-machine interaction panel signally connected with the controller and having a display screen, and a sensor located in the proximity of the air frying valve position limiter and used for sensing its position; when the cooking mode switching device is in the first state, the sensor sends a first signal to the controller and the controller commands the human-machine interaction panel to display a menu prompt corresponding to a pressure cooking mode; when the cooking mode switching device is in the second state, the sensor sends a second signal to the controller and the controller commands the human-machine interaction panel to display a menu prompt corresponding to a baking/air frying mode. Thus, when a user operates the cooking mode switching device to select a certain cooking mode, the display screen will automatically display a menu prompt corresponding to the mode and can thus timely guide the user's cooking, which is very convenient and friendly.

It should be understood that the above general description and the following detailed description are merely made by way of example for purposes of illustration and shall not limit the present invention.

### BRIEF DESCRIPTION OF THE DRAWINGS

FIG. 1 is a front view of a multifunctional cooking utensil according to a mode of realization of the present application.

FIG. 2 is a schematic view in perspective of the multifunctional cooking utensil shown in FIG. 1.

FIG. 3 is a schematic sectional view of the multifunctional cooking utensil shown in FIG. 1.

FIG. 4 is a schematic view in perspective of a utensil lid of the multifunctional cooking utensil shown in FIG. 1.

FIG. 5 is a schematic view in perspective of an inner lid of the utensil lid shown in FIG. 4, in which the cooking mode switching device is in a first state.

FIG. 6 is another schematic view in perspective of the inner lid of the utensil lid shown in FIG. 4, in which the cooking mode switching device is in the first state.

FIG. 7 is a schematic sectional view in perspective of the inner lid shown in FIGS. 5 and 6.

FIG. 8 is an enlarged view of the part A circled in FIG. 7.

FIG. 9 is another schematic sectional view in perspective of the inner lid shown in FIGS. 5 and 6.

FIG. 10 is an enlarged view of the part B circled in FIG. 9.

FIG. 11 is a schematic view in perspective of the inner lid of the utensil lid shown in FIG. 4, in which the cooking mode switching device is in a second state.

FIG. 12 is another schematic view in perspective of the inner lid of the utensil lid shown in FIG. 4, in which the cooking mode switching device is in the second state.

FIG. 13 is a schematic sectional view in perspective of the inner lid shown in FIGS. 11 and 12.

FIG. 14 is an enlarged view of the part A circled in FIG. 13.

FIG. 15 is another schematic sectional view in perspective of the inner lid shown in FIGS. 11 and 12.

FIG. 16 is an enlarged view of the part B circled in FIG. 15.

FIG. 17 is a schematic view in perspective of a cooking mode switching mechanism according to a mode of realization of the present application.

FIG. 18 is a schematic view in perspective of a cooking mode switching mechanism according to another mode of realization of the present application.

FIG. 19 is a schematic top view of a multifunctional cooking utensil including a cooking mode switching mechanism shown in FIG. 18.

FIG. 20 is a schematic view in perspective of the inner lid of the utensil lid of the multifunctional cooking utensil shown in FIG. 19, wherein the cooking mode switching device is in a first state.

FIG. 21 is a schematic view in perspective of the inner lid of the utensil lid of the multifunctional cooking utensil shown in FIG. 19, wherein the cooking mode switching device is in a second state.

FIG. 22 is a schematic view in perspective of an inner lid including a cooking mode switching mechanism according to a further mode of realization of the present application.

### LISTS OF REFERENCES

100 cooking utensil
102 utensil lid
101 L-shaped arm
1021 face lid
1022, 1022′ cooking mode switching device
1028 sensor
10221 button
1029 inner lid
10222 tip
10291 upper wall of the inner lid
1023 pressure relief valve
10292 cavity inside the inner lid
10231 valve body
103 handle
10232 valve spool
104 utensil body
1024 lever
1041 shell
10241 second end of the lever
1042 heat insulation hood
10242 first end of the lever
1043 inner pot
10243 fulcrum
1044 second heating element
1025 air frying valve
105 human-machine interaction panel
10251 head of the air frying valve
106 foot
10252 body of the air frying valve
107 venting conduit
10253 sealing ring
1071 venting passage
10254 lower surface of the head
1072 outlet of the venting passage of the air frying valve
10255 radial through hole
109 motor
1026, 1026′ air frying valve position limiter
1091 motor shaft
10261, 10261′ second end of the air frying valve
110 second fan position limiter
10262, 10262′ bent part of the air frying valve
111 first fan position limiter
10263, 10263′ first end of the air frying valve
112 first heating element position limiter
10264 first through hole;
10264′ slot
113 protective cover
10265 hole
10266 slope structure;
1027 C-shaped member;
10271 first end of the C-shaped member;
10272 second end of the C-shaped member;
102721 boss;

### DETAILED DESCRIPTION OF THE EMBODIMENTS

Exemplary modes of realization shown by way of example in the accompanying drawings will be described in detail here. When the following description refers to the drawings, unless otherwise indicated, the same references in different drawings designate the same or similar elements. The modes of realization described in the following exemplary modes of realization do not represent all modes of realization conform to the present invention. Instead, they are merely examples of means, systems, devices, and methods conform to some aspects of the present invention.

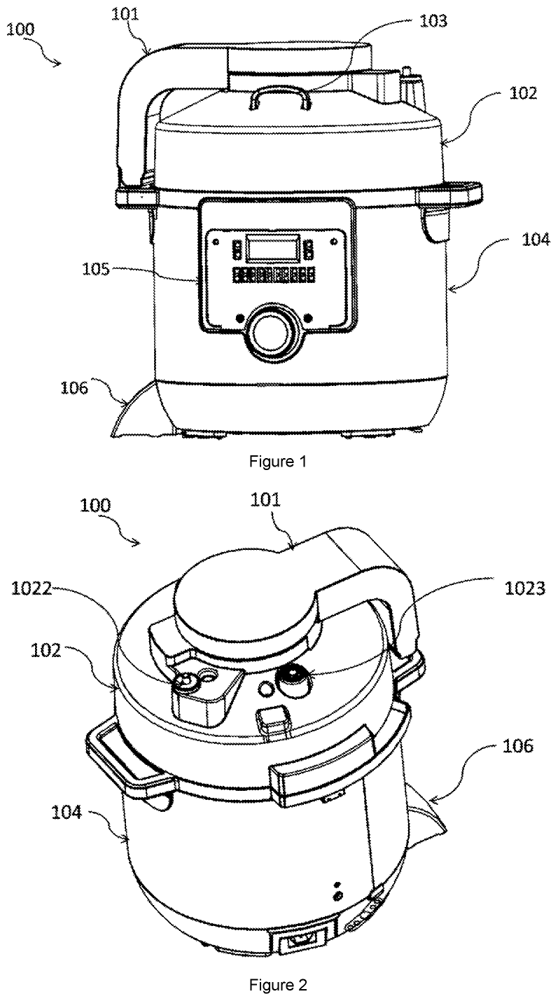

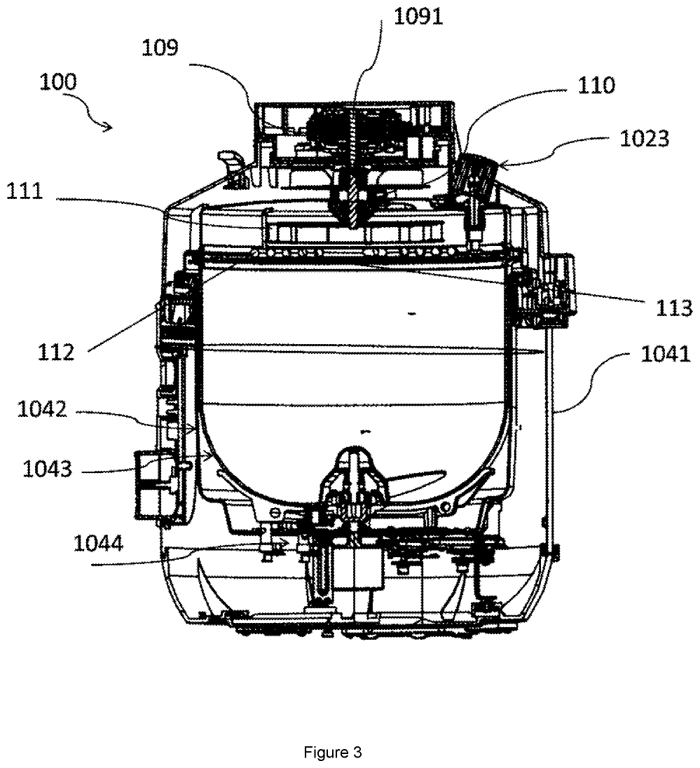

FIGS. 1 to 3 each generally show, in different views, a multifunctional cooking utensil 100 according to a mode of realization of the present application, which has an air frying/baking function and a pressure cooking function. The cooking utensil comprises a utensil body 104 and a lid assembly capable of sealingly covering the utensil body 104. As best illustrated by FIG. 3, the utensil body 104 comprises conventional structures such as a shell 1041, a heat insulation hood 1042 provided inside the shell 1041, and an inner pot 1043 for accommodating food that is received in the heat insulation hood 1042, which are not described in detail here. A hot air assembly capable of generating hot air and blowing it to food placed inside the inner pot 1043 to air fry or bake the food is provided inside the lid assembly. As shown in FIGS. 3, 7, and 9, the hot air assembly in the mode of realization comprises a first fan 111 driven to rotate by a motor 109 through a motor shaft 1091 and a first heating element 112 provided below the first fan 111, which can be any element capable of generating heat, such as a heating disk, an induction coil, for example, preferably a planar spiral heating tube. As shown in FIG. 3, a second heating element 1044 for heating the inner pot 1043 from the bottom is further provided inside a base of the utensil body 104. In this mode of realization, the lid assembly is pivotably hinged to the utensil body 104 and moveable between an open position and a closed position in which the lid assembly can be rotated so that an airtight locking or unlocking between the lid assembly and the utensil body can be achieved through the engagement or disengagement between a plurality of pot teeth spaced from each other and provided at a mouth of the heat insulation hood 1042 and corresponding lid teeth on the lid assembly. It should be understood that, the lid assembly can also be removably connected to the utensil body 104, i.e., it can sealingly cover the utensil body 104 while in use and can be conveniently removed from the utensil body while not in use. It should also be understood that, the lid assembly can be configured to sealingly cover the utensil body 104 without any rotation. A person skilled in the art knows various ways of providing a structure capable of achieving the above-described objective, which are not described in detail here.

In the above-described mode of realization, as shown in FIG. 1, the shell 1041 of the utensil body 104 is further provided with a human-machine interaction panel 105 that is signally connected with a controller (which is not illustrated and can be provided inside the utensil body or inside the lid assembly) and has a display screen on which various information useful for a user can be displayed under the control of the controller. Of course, the human-machine interaction panel 105 can also be provided at another position, for example, on the face lid 1021.

The lid assembly that can help the cooking utensil according to the present mode of realization realize multiple functions will be described in detail below with reference to the accompanying drawings.

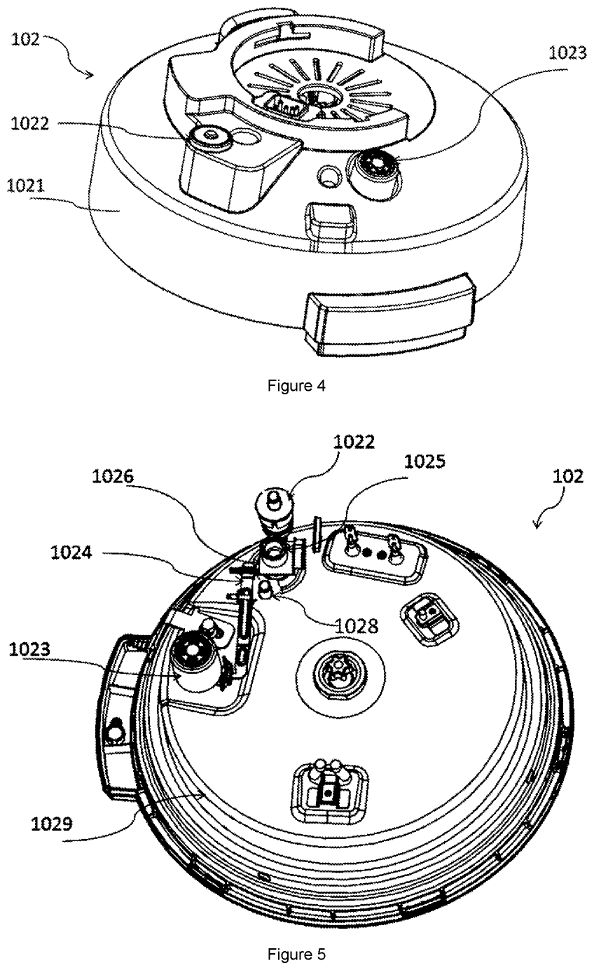

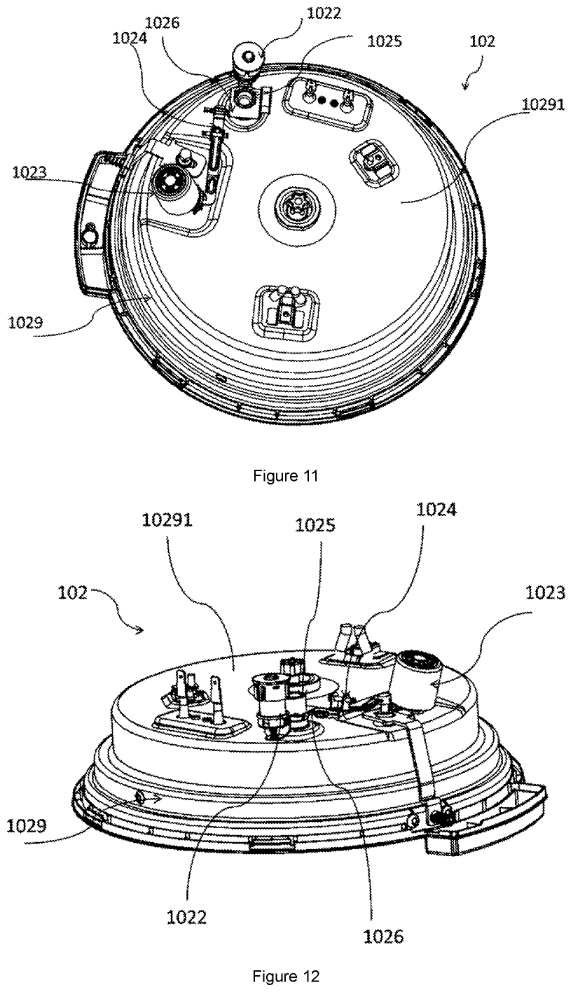

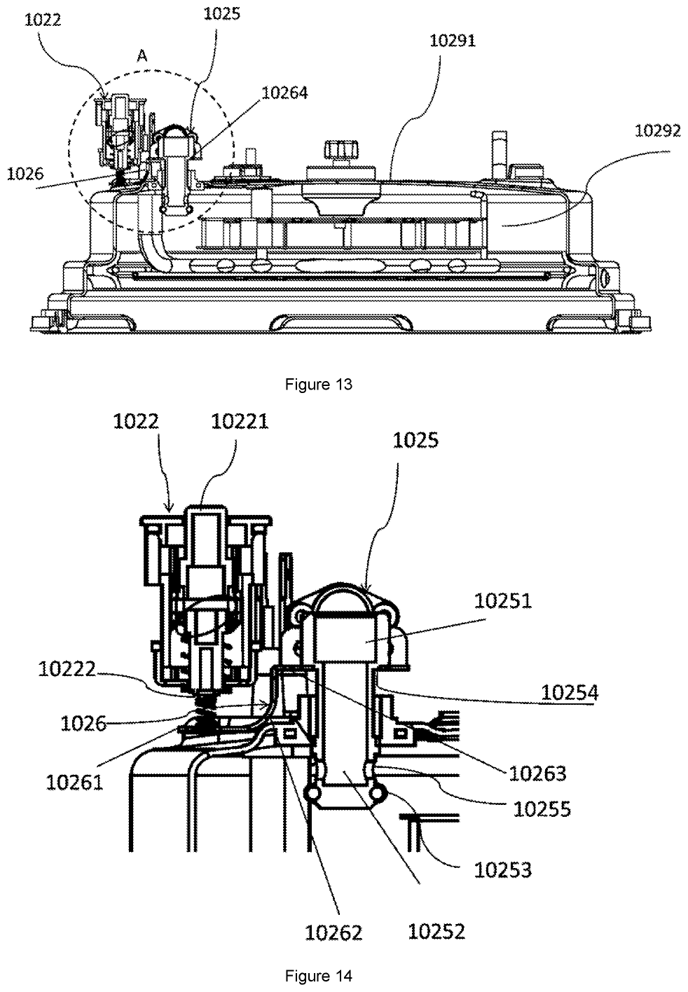

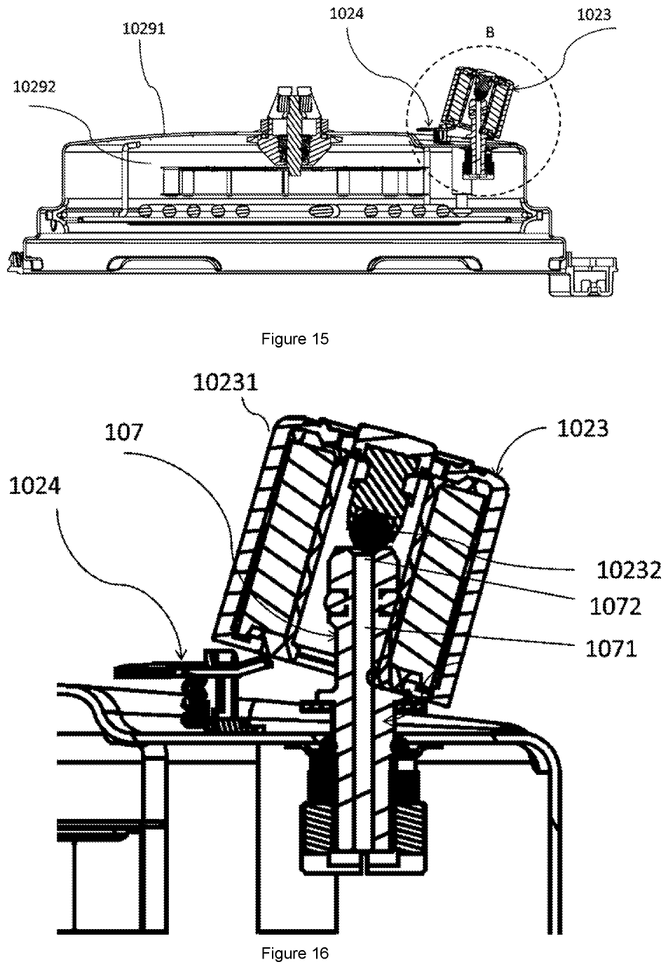

As shown in FIGS. 1 and 2, the lid assembly comprises a utensil lid 102 capable of sealingly covering the utensil body 104. As shown in FIGS. 4 and 5, the utensil lid comprises an inner lid 1029 and a face lid 1021 provided to cover the inner lid 1029. As shown in FIGS. 13 and 15, the inner lid 1029 has an upper wall 10291 and an inner cavity 10292 defined partially by the upper wall 10291, in which cavity the above-described hot air assembly is received. As best shown in FIGS. 5, 6, 11, and 12, the upper wall 10291 of the inner lid 1029 is provided with a cooking mode switching device 1022 and an air frying valve 1025, and an air frying valve position limiter 1026 located therebetween. When the cooking mode switching device 1022 is in a first state as shown in FIGS. 5 to 10, a first end 10263 of the air frying valve position limiter 1026 limits the air frying valve 1025 to a first position in which an airtight engagement is formed between the air frying valve 1025 and the upper wall 10291 of the inner lid 1029; when the cooking mode switching device 1022 is in a second state as shown in FIGS. 11 to 16, the first end 10263 of the air frying valve position limiter 1026 is pressed so that the air frying valve 1025 is released from the limitation of the first end 10263 and can, under the effect of its own weight (when the pressure exerted by air inside the utensil on the air frying valve is smaller than its own weight), switch to a second position in which a passage for air circulation is formed between the air frying valve 1025 and the upper wall 10291 of the inner lid 1029. A person skilled in the art can understand that, in the event that the lid assembly sealingly covers the utensil body 104, when the cooking mode switching device 1022 is in the first state, a sealed cooking chamber is formed between the lid assembly and the utensil body 104, at which time pressure cooking can be preformed on food in the cooking chamber, which is called “pressure cooking mode”; when the cooking mode switching device 1022 is in the second state, the cooking chamber between the lid assembly and the utensil body 104 can communicate with external atmosphere, at which time food inside the cooking chamber can be baked or air fried, which is called “air frying/baking mode”. The above-described solution allows the cooking utensil to have a pressure cooking function and an air frying/baking function by means of a simple and reliable structure without changing the lid assembly. To easily achieve the switching between different modes, a user need only simply operate the cooking mode switching device 1022, which is very convenient.

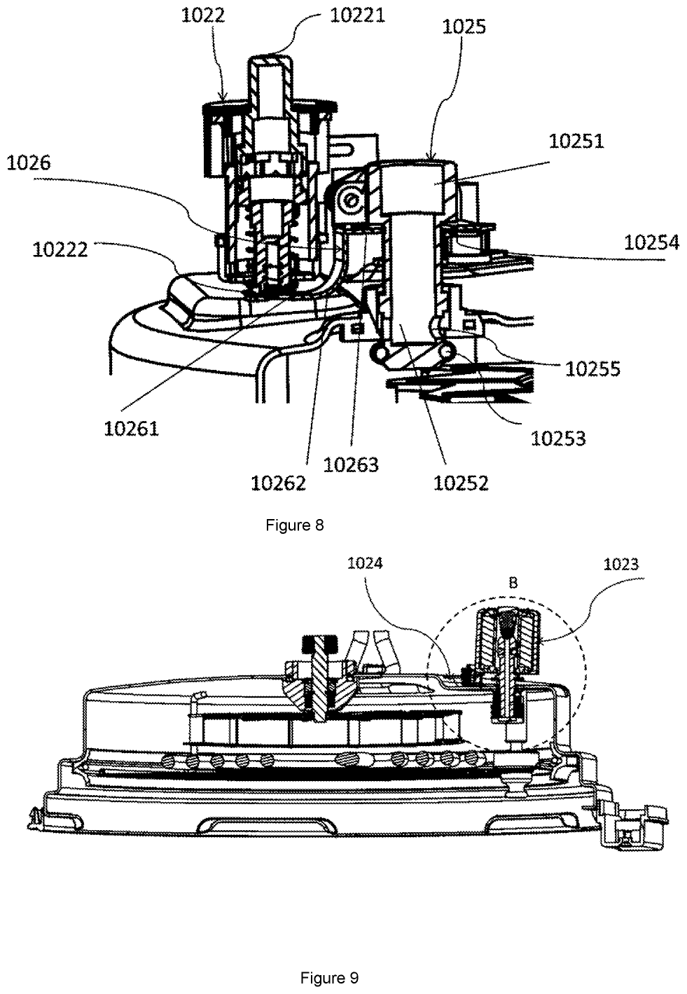

It can be clearly seen from the partially enlarged views in FIGS. 8 and 14 that, the cooking mode switching device 102 has a ball-point-pen-styled telescopic structure (as this structure is well known to a person skilled in the art, it is not described in detail here), comprising a button 10221 located at an upper end and a tip 10222 located at a lower end, the button 10221 extending upwards through the face lid 1021 so that it can be accessed by a user. When the button 10221 is not pressed and the tip 10222 is in a retracted position (FIG. 8), the cooking mode switching device 1022 is in the above-described first state, whereas when the button 10221 is pressed and the tip 10222 is in an extended position (FIG. 14), the cooking mode switching device 1022 is in the above-described second state. A person skilled in the art can understand that, the cooking mode switching device 1022 is further provided inside with means for maintaining the tip 10222 in the retracted and extended positions and reset means for returning it to the retracted position from the extended position, which means are conventional and therefore not described in detail. In the mode of realization illustrated, an elastic element connecting the tip 10222 and the upper wall 10291 of the inner lid 1029 is further provided at the bottom of the cooking mode switching device 1022. It should be understood that, the cooking mode switching device 1022 can also be of another structure so long as it is able to cause the air frying valve position limiter 1026 to move between a high position and a low position.

Similarly, as best shown in FIGS. 8 and 14, the air frying valve 1025 comprises a head 10251 and a body 10252 having an external radial dimension smaller than that of the head 10251 and fixed to the head, the head 10251 and the body 10252 having an axial fluid passage in communication with each other. In the mode of realization illustrated, the head 10251 is substantially a hollow circular cylinder with a large diameter and an axial through hole inside; the body 10252 is substantially a circular cylinder with a small diameter, of which an upper end is connected to the head 10251 and an outer surface of a lower end is provided with a sealing ring 10253 made of a material such as rubber or silicone and a radial through hole 10255 located above the sealing ring 10253. The body 10252 comprises inside an axial blind hole extending from the upper end face of the body to the radial through hole 10255, the axial blind hole being in fluid communication with the radial through hole 10255. Thus, the axial blind hole and the axial through hole of the head 10251 together constitute an axial fluid passage for air circulation. Preferably, the head 10251 and the body 10252 are integrally formed so that the air frying valve 1025 is easy to manufacture and has high mechanical resistance. Preferably, the outer surface of the lower end of the body 10252 is provided with a groove receiving the sealing ring 10253. Thus, the sealing ring is not susceptible of disengaging and a better sealing result can be ensured.

Still with reference to FIGS. 8 and 14, in the present mode of realization, the first end 10263 of the air frying valve position limiter 1026 is a platform that extends substantially in a horizontal direction and is provided with a first through hole 10264 in the middle, the lower surface 10254 of the head 10251 of the air frying valve 1025 is supported on the platform, and the body 10252 of the air frying valve 1025 is slidably provided inside the first through hole 10264. The air frying valve position limiter 1026 further comprises a second end 10261 and a bent part 10262 connecting the first end 10263 and the second end 10261, wherein the second end 10261 is fixed to the tip 10222 of the cooking mode switching device 1022 and thus able to move up and down with it. In the present mode of realization, the second end 10261 is provided with a hole 10265 inside which the tip 10222 is fixed. Thus, the second end 10261 of the air frying valve position limiter 1026 is not susceptible of disengaging from the tip 10222, providing reliable connection. It should be understood that the shape and configuration of the air frying valve position limiter 1026 are not limited to this example.

When the cooking mode switching device 1022 is in the first state as shown in FIGS. 5 to 10, the second end 10261 of the air frying valve position limiter 1026 has not been pressed by the tip 10222, therefore its first end 10263 is in a high position. Since the head 10251 of the air frying valve 1025 is supported on the first end 10263, the air frying valve 1025 is also maintained in a high position (i.e., the first position), so that the sealing ring 10253 at the lower end of its body is pressed against an inner surface of the upper wall 10291 of the inner lid 1029 and thus forms sealed engagement with the upper wall 10291. At this moment, the cooking chamber is kept sealed and food inside the inner pot 1043 can be pressure cooked by turning on the first heating element 112 and/or the second heating element 1044. When the cooking mode switching device 1022 is in the second state as shown in FIGS. 11 to 16, the second end 10261 of the air frying valve position limiter 1026 is pressed by the tip 10222 and drives its first end 10263 to move downward to a low position, at which time the head 10251 of the air frying valve 1025 loses the support of the first end 10263 and therefore, when the force exerted by air inside the cooking chamber on the lower end of the air frying valve 1025 is smaller than the air frying valve 1025's own weight, the air frying valve 1025 will automatically fall to a low position (i.e., the second position), so that the sealing ring 10253 at the lower end of its body leaves the inner surface of the upper wall 10291 of the inner lid 1029 and the radial through hole 10255 comes to a position in fluid communication with the cavity 10292 inside the inner lid 1029, thus achieving fluid communication between the cavity 10292 and the axial fluid passage inside the air frying valve 1025. At this moment, the cooking chamber is in communication with external atmosphere and food inside the inner pot 1043 can be air fried/baked by turning on the first heating element 112 and the first fan 111 (and if necessary, the second heating element 1044). Of course, if the force exerted by air inside the cooking chamber on the lower end of the air frying valve 1025 when the air frying valve position limiter 1026 is at the low position is larger than or equal to the air frying valve 1025's own weight, then an pressure relief operation needs to be performed to the cooking chamber. In some modes of realization, manual pressure relief is performed by loosening the utensil lid by rotation, until the air frying valve 1025 is able to overcome air pressure inside the cooking chamber and drop to the low position, and then the utensil lid is tightened by rotation again so that it sealingly covers the utensil body. In the mode of realization illustrated, this pressure relief operation can be achieved automatically while pressing the button 10221 of the cooking mode switching device 1022, thanks to a pressure relief valve 1023 provided on the upper wall 10291 of the inner lid 1029.

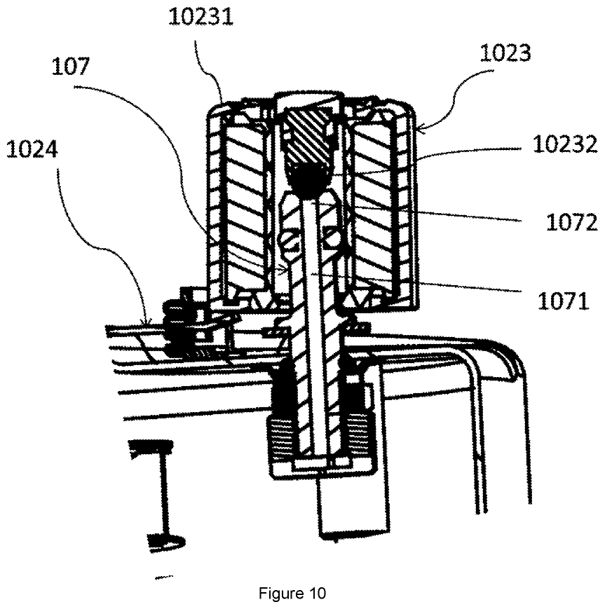

As shown in FIGS. 5 to 6 and 11 to 12, the pressure relief valve 1023 is provided in the proximity of the air frying valve 1025 and a lever 1024 is provided between the pressure relief valve 1023 and the air frying valve position limiter 1026. When the cooking mode switching device 1022 is in the first state as shown in FIGS. 5 to 10, the pressure relief valve 1023 is in a third position in which an airtight engagement is formed between the pressure relief valve 1023 and the upper wall 10291 of the inner lid 1029. When the cooking mode switching device 1022 is in the second state as shown in FIGS. 11 to 16, the first end 10263 of the air frying valve position limiter 1026 presses a first end 10242 of the lever 1024 so that the pressure relief valve 1023, under the effect of a lifted second end 10241 of the lever 1024, switches to a fourth position in which a passage for air circulation is formed between the pressure relief valve 1023 and the upper wall 10291 of the inner lid 1029. With reference to FIGS. 10 and 16, the pressure relief valve 1023 comprises a valve body 10231 and a valve spool 10232 provided inside the valve body 10231. When the valve body 10231 of the pressure relief valve 1023 is not lifted by the second end 10241 of the lever 1024 (i.e., in the third position), the valve spool 10232 is pressed against an outlet 1072 of a venting passage 1071 of a venting conduit 107 vertically inserted in the upper wall 10291 of the inner lid 1029, forming an airtight engagement, at which time an airtight engagement is also formed between the air frying valve 1025 and the upper wall 10291, thus forming a sealed cooking chamber and one is able to perform pressure cooking. When the valve body 10231 of the pressure relief valve 1023 is lifted by the second end 10241 of the lever 1024 (i.e., in the fourth position), the valve spool 10232 is offset from the outlet 1072 and thus disengages from it, so that the cavity 10292 inside the inner lid 1029 is in communication with external atmosphere via the venting passage 1071. At this time, the air frying valve 1025 either has dropped to the low position under the effect of its own weight (for example, when an air frying/baking mode is directly selected when the pot is not pressured inside) so that the cavity 10292 is in communication with external atmosphere also at the air frying valve 1025, or is still pressed by high pressure air inside the cooking chamber and maintained in the high position (for example, when directly switching from a pressure cooking mode to an air frying/baking mode) and maintains an airtight engagement with the upper wall 10291 of the inner lid 1029. In the former situation, as there is a venting outlet at both the pressure relief valve 1023 and the air frying valve 1025, venting flow can be increased, better meeting the venting requirement of an air frying/baking mode. In the latter situation, pressure is first relieved via the fluid passage at the pressure relief valve 1023 (i.e. exhaust mode) and when the pressure drops to a certain degree, the air frying valve 1025 overcomes air pressure inside the cooking chamber and drops to the low position, providing anther venting outlet for the fluid inside the cooking chamber, at which time the first heating element 112 and the first fan 111 (and if necessary, the second heating element 1044) can be turned on to air fry/bake food inside the inner pot 1043. It can be seen from the above description that, as the movement of the cooking mode switching device 1022 is linked to that of the air frying valve position limiter 1026 and the lever 1024, a user only needs to simply press the button 10221 of the cooking mode switching device 1022 to achieve mode switching and venting for pressure relief at the same time, leading to a facilitated operation and a reliable result.

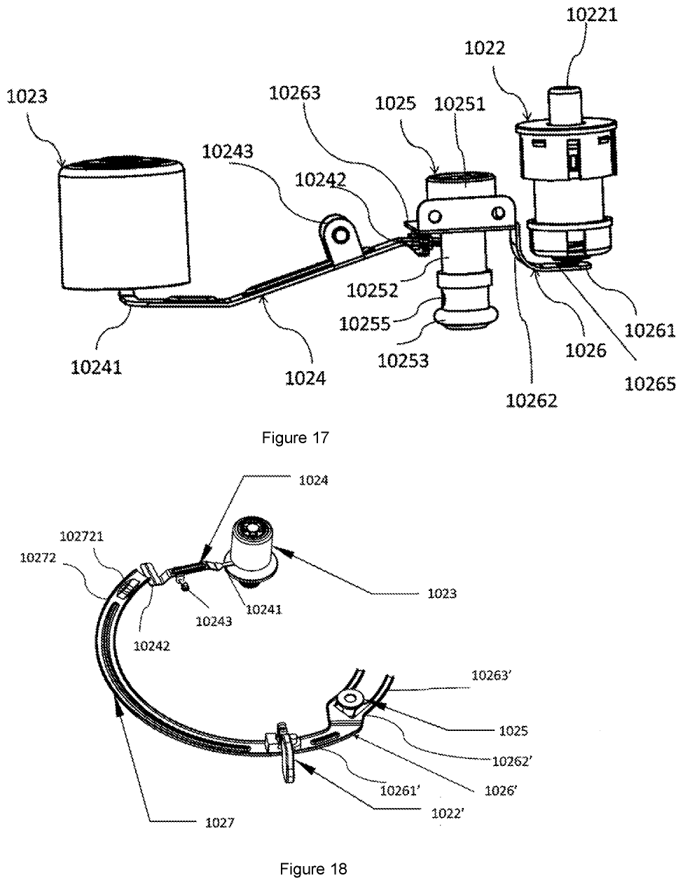

In the present mode of realization, as best shown in FIG. 17, the lever 1024 comprises a first section and a second section both extending substantially in a horizontal direction, a middle section connecting the first section and the second section, and a fulcrum 10243 provided at the middle section. The first section comprises the above-described first end 10242 of the lever 1024, and the second section comprises the above-described second end 10241 of the lever 1024. The first end 10242 of the lever 1024 abuts against the lower surface of the first end 10263 of the air frying valve position limiter 1026, and the second end 10241 of the lever abuts against a lower surface of the valve body 10231 of the pressure relief valve 1023. As the first end 10242 and the second end 10241 of the lever 1024 both extend substantially in a horizontal direction, they can better fit the surfaces against which they abut respectively, achieving accurate and smooth motion transmission. In the present mode of realization, the fulcrum 10243 comprises a rotary shaft fixed to a lower surface of the face lid 1021. In another mode of realization, the fulcrum 10243 is fixed to the upper wall 10291 of the inner lid 1029 via a support for example. It should be understood that the lever 1024 can also be of another structure so long as it is able to lift the valve body 10231 of the pressure relief valve 1023 when the air frying valve position limiter 1026 is in the low position and to let the valve body 10231 of the pressure relief valve 1023 drop down when the air frying valve position limiter 1026 is in the high position. It should also be understood that a person skilled in the art is able to adjust parameters such as the location of the fulcrum 10243, the length of the lever arms on the two sides of the fulcrum, and the ratio between the two arms based on factors such as the distance between the air frying valve position limiter 1026 and the pressure relief valve 1023, the course of the first end of the air frying valve position limiter 1026, and the height by which the pressure relief valve 1023 needs to be lifted.

As shown in FIGS. 1 and 2, the lid assembly according to the present mode of realization further comprises an L-shaped arm 101 coupled to the utensil lid 102 which is rotatable in a horizontal plane relative to the arm 101 so as to achieve an airtight locking or unlocking with the utensil body 104. The arm comprises a horizontal part extending substantially in a horizontal direction inside which the motor 109 is located and a vertical part extending substantially in a vertical direction. As such, the motor 109 and associated electrical elements are separately located in the horizontal part of the arm 101, not susceptible to damage caused by inference of other parts, which also facilitates maintenance and repair. In addition, as most electrical elements are not located inside the utensil lid 102, it is convenient to clean the utensil lid after it is detached. As shown in FIG. 1, the lid assembly can be hinged to the utensil body 104 by means of the vertical part of the arm 101 so that the lid assembly is able to pivot around a hinge axe between an open position and a closed position. A user can hold the arm 101, especially the bent part connecting the horizontal part and the vertical part, to perform operations of opening and closing the lid assembly. As the lid assembly has a relatively large weight, when it pivots around the hinge axe to the open position, it will cause the center of gravity of the entire cooking utensil to shift, which may cause the cooking utensil to roll over. To reduce this risk, the cooking utensil according to the present mode of realization further comprises a foot 106 extending radially from the bottom of the utensil body 104 and located at the same side of the utensil body 104 as the hinge, preferably just below the hinge. A person skilled in the art can adapt the size and shape of the foot 106 based on actual needs. In other modes of realization, the lid assembly does not comprise the arm 101, in which case the motor 109 can be provided inside the utensil lid 102 or at any other appropriate location.

In addition, to further facilitate operations of opening, closing, and rotating the lid assembly, as shown in FIG. 1, a handle 103 that facilitates holding is further provided at an appropriate location of the face lid 1021 and can be for example in the shape of a ring.

As shown in FIG. 3, the lid assembly according to the present mode of realization further comprises a second fan 110 located between the upper wall 10291 of the inner lid 1029 and the face lid 1021, the second fan 110 being connected to the motor shaft 1091 and driven by the motor 109 to rotate. The second fan can dissipate heat from the space between the upper wall 10291 and the face lid 1021, preventing the utensil lid from being overheated while preventing excessive heat from being transmitted to the motor 109 to affect its service life. In addition, the lid assembly according to the present mode of realization further comprises a protective cover 113 located below the first heating element 112 for preventing grease and smoke inside the inner pot 1043 from polluting the hot air assembly.

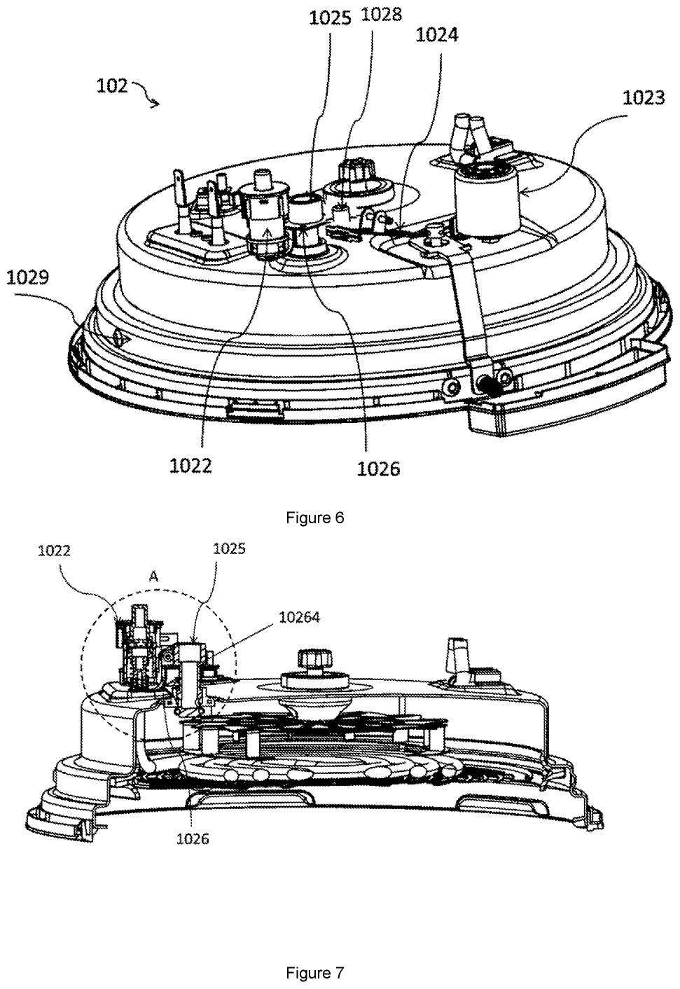

As schematically shown in FIGS. 5 and 6, the lid assembly according to the present mode of realization further comprises a sensor 1028 located in the proximity of the air frying valve position limiter 1026 and configured to detect its position (for example, a contact sensor or a proximity sensor). When the cooking mode switching device 1022 is in the first state (correspondingly, the air frying valve position limiter 1026 is in the high position), the sensor 1028 sends a first signal to the controller and the controller commands the human-machine interaction panel 105 to display a menu prompt corresponding to a pressure cooking mode. When the cooking mode switching device 1022 is in the second state (correspondingly, the air frying valve position limiter 1026 is in the low position), the sensor 1028 sends a second signal to the controller and the controller commands the human-machine interaction panel 105 to display a menu prompt corresponding to a baking/air frying mode. Thus, when a user operates the cooking mode switching device 1022 to select a certain cooking mode, a menu prompt corresponding to the mode is automatically displayed on the display screen, which can guide the user's cooking in a timely manner.

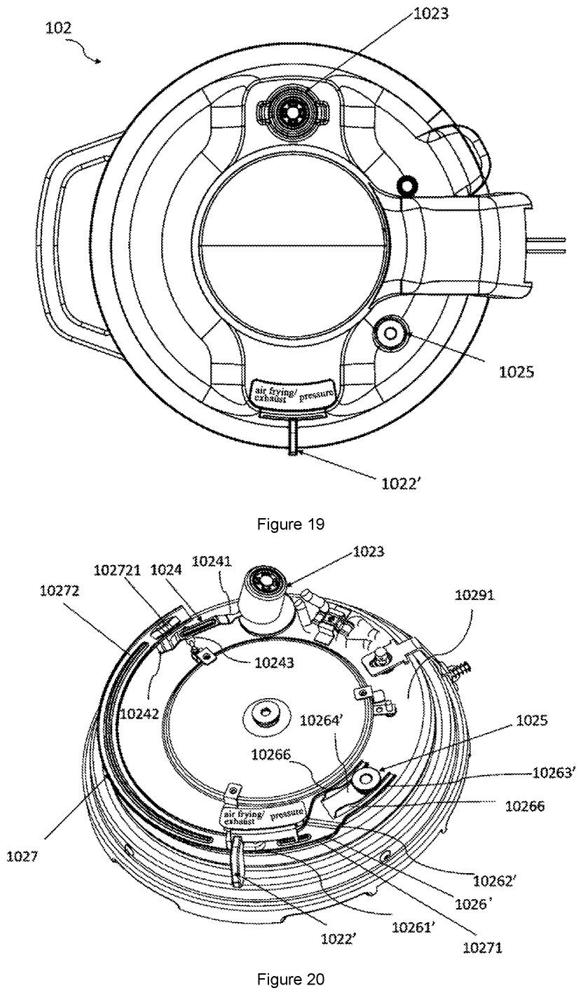

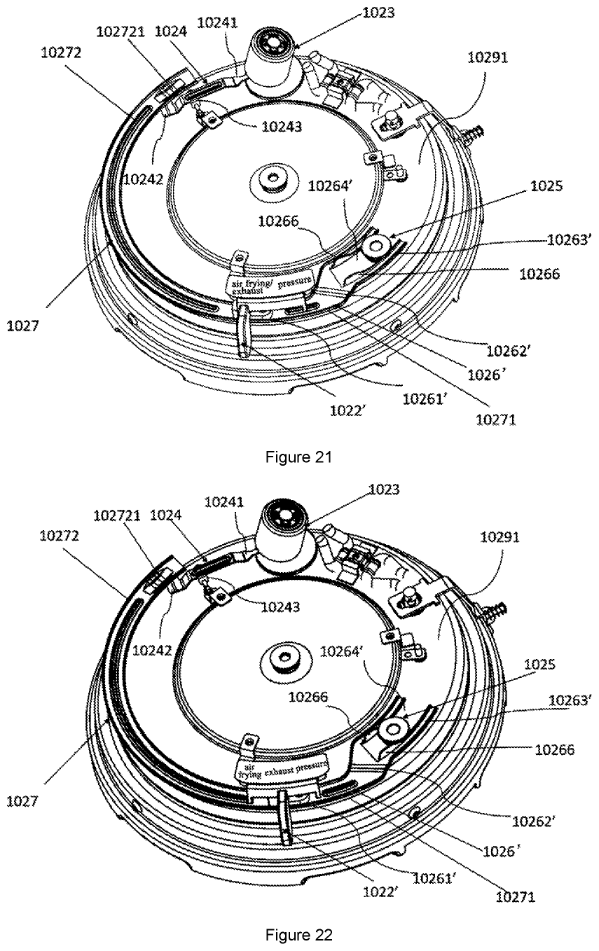

Referring to FIGS. 18 to 21, a multifunctional cooking utensil according to another mode of realization of the present application will be described, which differs from the previous mode of realization only in the specific structure of the cooking mode switching mechanism. Specifically, in the modes of realization shown in FIGS. 18 to 21, the cooking mode switching mechanism includes a cooking mode switching device 1022 ‘and an air frying valve 1025 arranged on the upper wall 10291 of the inner lid 1029, and an air frying valve position limiter 1026’ located therebetween, wherein the air frying valve position limiter 1026′ is formed by a first end 10271 of a C-shaped member 1027 extending circumferentially along the edge of the upper wall 10291 of the inner lid, The cooking mode switching device 1022′ is formed by a rod fixed to the C-shaped member 1027, which rod is located between two ends 10271 and 10272 of the C-shaped member 1027 and extends through the face lid 1021 so that it can be moved by the user, and can have any shape that allows it to be easily moved. When the rod is in the first state as shown in FIG. 20, the first end 10263′ of the air frying valve position limiter 1026′ limits the air frying valve 1025 to the first position in which a sealed engagement is formed between the air frying valve 1025 and the upper wall 10291 of the inner lid 1029. When the rod is in the second state as shown in FIG. 21, the first end 10263′ of the air frying valve position limiter 1026′ is driven to move in the clockwise direction, so that the air frying valve 1025 gets rid of the limit of the first end 10263′ and can be switched to the second position under its own gravity (when the pressure exerted on the air frying valve by the gas in the utensil is less than its own gravity), In the second position, a passage for air circulation is formed between the air frying valve 1025 and the upper wall 10291 of the inner lid 1029. It can be understood by those skilled in the art that in the event that the lid assembly sealingly covers the utensil body 104, when the cooking mode switching device 1022′ is in the first state, a sealed cooking chamber is formed between the lid assembly and the utensil body 104. At this time, the food in the cooking chamber can be pressure cooked, which is the pressure cooking mode; when the cooking mode switching device 1022′ is in the second state, the cooking chamber between the lid assembly and the utensil body 104 can be in communication with the outside atmosphere. At this time, the food in the cooking chamber can be baked or air fried, which is the air frying/baking mode. Users can easily switch between different modes by simply operating the rod, which is very convenient.

As shown in FIGS. 18, 20 and 21, the air frying valve position limiter 1026′ includes a first end 10263′, a second end 10261′, and a bent part 10262′ connecting the first end 10263′ and the second end 10261′, wherein the first end 10263′ is a U-shaped structure (or a fork-shaped structure) extending substantially in the horizontal direction, and the second end 10261′ is fixed to the cooking mode switching device 1022′ (ie, the rod) and can move left and right therewith. The upper surfaces of the two sides of the U-shaped structure are respectively provided with a slope-shaped structure 10266, the lower surface 10254 of the head 10251 of the air frying valve 1025 is supported on the slope-shaped structure 10266, and the body 10252 of the air frying valve 1025 is slidablely provided in the slot 10264′ between the two sides of the U-shaped structure. The height of the slope-shaped structure 10266 gradually increases in the clockwise direction, that is, the closer it is to the air frying valve 1025, the smaller the height is, and the farther away from the air frying valve 1025, the greater the height is. In this way, when the rod is moved to the pressure mode (FIG. 20), the first end 10263′ of the air frying valve position limiter 1026′ moves counterclockwise under the driving of the rod, such that the air frying valve 1025 slides clockwise relative to the slope-shaped structure 10266, that is, moves toward the end of the slope-shaped structure 10266 with a greater height, thereby causing the air frying valve 1025 to be lifted upwards, which makes the sealing ring 10253 at the lower end of the body of the air frying valve 1025 is pressed against the inner surface of the upper wall 10291 of the inner lid 1029 to form a sealed engagement with the upper wall 10291 of the inner lid 1029. At this time, the cooking chamber is kept sealed, and the food in the inner pot 1043 can be pressure-cooked by turning on the first heating element 112 and/or the second heating element 1044. When the rod is moved to the air frying/exhaust mode (FIG. 21), the first end 10263′ of the air frying valve position limiter 1026′ moves clockwise under the drive of the rod, such that the air frying valve 1025 slides counterclockwise relative to the slope-shaped structure 10266, that is, moves toward the end of the slope-shaped structure 10266 with a smaller height, thereby causing the air frying valve 1025 to gradually lose support. When the force exerted by the gas in the cooking chamber on the lower end of the air frying valve 1025 is smaller than the gravity of the air frying valve 1025 itself, the air frying valve 1025 will automatically drop to a low position (ie, the second position), so that the sealing ring 10253 at the lower end of its body leaves the inner surface of the upper wall 10291 of the inner lid 1029 and the radial through hole 10255 comes to a position in fluid communication with the inner cavity 1029 inside the inner lid 1029, which makes the inner cavity 10292 be in fluid communication with the axial fluid passage inside the air frying valve 1025. At this time, the cooking chamber is in communication with the outside atmosphere, and the first heating element 112 and the first fan 111 (and the second heating element 1044 if necessary) can be turned on to air fry/bake the food in the inner pot 1043. Of course, if when the air frying valve 1025 loses the support of the first end 10263′ of the air frying valve position limiter 1026′, the force exerted by the gas in the cooking chamber on the lower end of the air frying valve 1025 is greater than or equal to the gravity of the air frying valve 1025 itself, It is necessary to depressurize the cooking chamber. In some embodiments, manual pressure relief is performed by unscrewing the lid of the utensil until the air frying valve 1025 can overcome the gas pressure in the cooking chamber to drop to a low position, and then the utensil lid is re-tightened so that it is tightly closed on the on the utensil body. In the illustrated embodiment, the pressure relief operation can be automatically realized when the rod is moved to the left, thanks to the pressure relief valve 1023 provided on the upper wall 10291 of the inner lid 1029.

As shown in FIG. 20-21, the pressure relief valve 1023 is arranged near the second end 10272 of the C-shaped member 1027, and a lever 1024 is arranged between them. When the cooking mode switching device 1022′ is in the first state as shown in FIG. 20, the pressure relief valve 1023 is in the third position in which a sealed engagement is formed between the pressure relief valve 1023 and the upper wall 10291 of the inner lid 1029. When the cooking mode switching device 1022′ is in the second state as shown in FIG. 21, the second end 10272 of the C-shaped member 1027 presses the first end 10242 of the lever 1024 to make the pressure relief valve 1023 switch to the fourth position under the action of the raised second end 10241 of the lever 1024. In the fourth position, a passage for air circulation is formed between the pressure relief valve 1023 and the upper wall 10291 of the inner lid 1029. In the mode of realization shown in FIGS. 18-21, the lower surface of the second end 10272 of the C-shaped member 1027 is provided with a boss 102721. When the rod drives the C-shaped member 1027 to move clockwise (that is, when switching to the air frying (or baking)/exhaust mode), the boss 102721 comes into contact with and presses the first end 10242 of the lever 1024 to make the second end 10241 of the lever 1024 rise, thereby lifting the pressure relief valve 1023 to the fourth position. When the rod drives the C-shaped member 1027 to move counterclockwise (that is, when switching to the pressure mode), the boss 102721 gradually loses contact with the first end 10242 of the lever 1024. Since the first end 10242 is no longer pressed, the second end 10241 of the lever 1024 will fall back to the initial position under the gravity of the pressure relief valve 1023. At this time, the pressure relief valve 1023 comes to the third position in which it is sealingly engaged with the upper wall 10291 of the inner lid 1029. In this mode of realization, the structure and working principle of pressure relief valve 1023 and lever 1024 are basically the same as those in the preceding mode of realization, so they will not be described in detail here. Since the cooking mode switching device 1022′ is linked with the air frying valve position limiter 1026′ and the lever 1024, the user only needs to simply toggle the cooking mode switching device 1022′ to achieve mode switching and exhaust for pressure relief at the same time. The operation is convenient and the results are reliable. Moreover, compared with the previous mode of realization, the selection of position for the pressure relief valve 1023 and air frying valve 1025 is more flexible. For example, to prevent users from being scalded by steam, the pressure relief valve 1023 and air frying valve 1025 can be provided at a position far away from the rod.

In the mode of realization shown in FIGS. 18-21, the rod can move between the two positions corresponding to the air frying (or baking)/exhaust mode and the pressure mode. However, in order to better conform to the usage habits of some users and make the function markings clearer, as shown in FIG. 22, the air frying (or baking) mode and exhaust mode can also be arranged at two different positions, but in both positions, the second end 10272 of the C-shaped member 1027 presses the first end 10242 of the lever 1024, so that the second end 10241 of the lever 1024 lifts the pressure relief valve 1023 to form a passage for air circulation. The functioning of the multifunctional cooking utensil 100 according to the above described modes of realization is briefly described below.

First, food to be cooked and seasoning needed are placed inside the inner pot 1043. Then the utensil body 104 is covered sealingly by the lid assembly. Power is turned on, the cooking mode switching device 1022 is operated to select a desired cooking mode, and specific cooking parameters (such as duration, temperature, and taste) under that mode are set on the human-machine interaction panel 105. Specifically, the desired mode is entered by pressing the cooking mode switching device 1022 or toggling the cooking mode switching device 1022′.

The terms used in the present application are only for the purpose of describing specific modes of realization and are not intended to limit the present invention. The singular forms “a” “an” and “the” used in the present application are also intended to include plural forms, unless the context clearly indicates otherwise. It should also be understood that the term “and/or” that may be used herein refers to and includes any or all possible combinations of one or more associated listed items.

Terms such as “upper,” “lower,” “left,” “right,” “front,” “rear,” “thickness,” “radial,” and “axial” that may be used herein to indicate relative positions in space are used to describe the relationship of one feature relative to another feature as shown in the drawings for the purpose of facilitating description, which is not limited to one position or one spatial orientation. It can be understood that, depending on the placement of a product, terms of relative positions in space may be intended to include different positions and orientations other than those shown in the figures and should not be understood as a limitation. In addition, the descriptive word “horizontal” that may be used herein is not completely equivalent to being in a direction perpendicular to gravity direction but allows a certain angle of inclination. The words “include” or “comprise” and similar words used herein mean that the elements or objects appearing before “include” or “comprise” encompass the elements or objects listed after “include” or “comprise” and their equivalents and do not exclude other elements or objects.

It should be noted that when an element is said to be “fixed to” another element, it can be directly on a surface of the other element, or it can be spaced apart from a surface of the other element by a distance. Terms such “installed/mounted”, “connected”, “linked” and “fixed” should be understood in a broad sense. For example, it can refer to a fixed connection, a detachable connection, or integrally formed; it can refer to a mechanical connection, an electrical connection or a mutual communication; it can refer to a direct connection, an indirect connection through an intermediary, or an internal communication between two elements or an interaction relationship between two elements, unless specifically defined otherwise.

In the present application, unless expressly stipulated and defined otherwise, a first feature being “above” or “below” a second feature may involve direct contact between the first and second features, or indirect contact through an intermediary between the first and second features. Moreover, a first feature being “on”, “above” or “on top of” a second feature can mean that the first feature is, exactly or with an offset, above the second feature, or only mean that the horizontal height of the first feature is larger than the second feature. A first feature being “under,” “below,” or “beneath” a second feature can mean that the first feature is, exactly or with an offset, below the second feature, or only mean that the horizontal height of the first feature is smaller than the second feature

It should be understood that the words “first” and “second” and similar words used in the specification of the present application do not denote any order, quantity, or importance, but are only used to distinguish different components. Words such as “multiple/a plurality of” and “multiple/a plurality of layers” mean two or more than two in number.

What have been described above are merely preferred modes of realization of the present invention and are not intended to limit the present invention. Any modification, equivalent replacement, or improvement made within the spirit and principle of the present invention shall fall within the scope of protection of the present application.

1. A lid assembly for multifunctional cooking utensil, comprising a utensil lid capable of covering the cooking utensil, the utensil lid comprising:
an inner lid having an upper wall and a cavity defined partially by the upper wall;
a face lid covering the inner lid; and
a hot air assembly located in the cavity inside the inner lid,
characterized in that,
the lid assembly further comprises a cooking mode switching device and an air frying valve provided at the upper wall of the inner lid, wherein an air frying valve position limiter is provided between the cooking mode switching device and the air frying valve;
when the cooking mode switching device is in a first state, a first end of the air frying valve position limiter limits the air frying valve to a first position in which an airtight engagement is formed between the air frying valve and the upper wall of the inner lid; and
when the cooking mode switching device is in a second state, the air frying valve is released from the limitation of the first end and can, under the effect of its own weight, switch to a second position in which a passage for air circulation is formed between the air frying valve and the upper wall of the inner lid.

2. The lid assembly according to claim 1, wherein the cooking mode switching device has a ball-point-pen-style telescopic structure comprising a button located at an upper end and a tip located at a lower end, the button extending upward through the face lid so that it can be accessed by a user;
wherein when the button is not pressed and the tip is in a retracted position, the cooking mode switching device is in the first state; and
wherein when the button is pressed and the tip is in an extended position, the cooking mode switching device is in the second state.

3. The lid assembly according to claim 2, wherein the air frying valve comprises a head and a body that has an external radial size smaller than that of the head and is fixed to the head, the head and the body having an axial fluid passage in communication with each other;
wherein the first end of the air frying valve position limiter is a platform that extends substantially in a horizontal direction and is provided in the middle with a first through hole, a lower surface of the head of the air frying valve being supported on the platform, and the body of the air frying valve being slidably provided in the first through hole; and
wherein the air frying valve position limiter further comprises a second end fixed to the tip of the cooking mode switching device so that it can move up and down with the tip.

4. The lid assembly according to claim 1, wherein the cooking mode switching device is a rod fixed to a second end of the air frying valve position limiter and extending through the face lid to be accessible by a user, the rod being moveable between two positions corresponding to the first state and the second state respectively.

5. The lid assembly according to claim 4, wherein the air frying valve comprises a head and a body that has an external radial size smaller than that of the head and is fixed the head, the head and the body having an axial fluid passage in communication with each other; and
the first end of the air frying valve position limiter is a U-shaped structure extending substantially in a horizontal direction, two sides of the U-shaped structure each being provided on its upper surface with a slope-shaped structure, a lower surface of the head of the air frying valve being supported on the slope-shaped structure while the body of the air frying valve being slidably arranged in a slot between the two sides of the U-shaped structure.

6. The lid assembly according to claim 3, wherein the body of the air frying valve is provided at a lower end with a sealing ring and a radial through hole located above the sealing ring;
wherein when the air frying valve is in the first position, an airtight engagement is formed between the sealing ring and the upper wall of the inner lid; and
wherein when the air frying valve is in the second position, the cavity inside the inner lid is in fluid communication with the axial fluid passage via the radial through hole.

7. The lid assembly according to claim 1, wherein the hot air assembly comprises a first fan driven by a motor and a first heating element provided below the first fan.

8. The lid assembly according to claim 7, further comprising an L-shaped arm coupled to the utensil lid, the arm comprising a horizontal part extending substantially in a horizontal direction and a vertical part extending substantially in a vertical direction, the motor being located in the horizontal part.

9. The lid assembly according to claim 7, further comprising a second fan located between the upper wall of the inner lid and the face lid, the second fan being driven by the motor.

10. (canceled)

11. The lid assembly according to claim 1, further comprising a sensor located in the proximity of the air frying valve position limiter and used for sensing its position.

12. The lid assembly according to claim 1, further comprising a pressure relief valve provided at the upper wall of the inner lid, and a lever which comprises a first end in contact with the pressure relief valve and a second end opposite the first end;
wherein when the cooking mode switching device is in the first state, the pressure relief valve is in a third position in which an airtight engagement is formed between the pressure relief valve and the upper wall of the inner lid; and
wherein when the cooking mode switching device is in the second state, the first end of the lever is pressed down so that the pressure relief valve is switched, under the action of the second end of the lever, to a fourth position in which a passage for air circulation is formed between the pressure relief valve and the upper wall of the inner lid.

13. The lid assembly according to claim 11, wherein the lever is arranged between the air frying valve position limiter and the pressure relief valve; and
wherein when the cooking mode switching device is in the second state, the first end of the lever is pressed down by the first end of the air frying valve position limiter.

14. The lid assembly according to claim 11, further comprising a C-shaped member extending circumferentially along an edge of the upper wall of the inner lid, the air frying valve position limiter being formed by a first end of the C-shaped member, and the lever being arranged between a second end of the C-shaped member and the pressure relief valve; and
wherein when the cooking mode switching device is in the second state, the first end of the lever is pressed down by the second end of the C-shaped member.

15. The lid assembly according to claim 11, wherein the pressure relief valve comprises a valve body and a valve spool provided inside the valve body;
wherein when the pressure relief valve is in the third position, the valve spool forms an airtight engagement with an outlet of a venting passage of a venting conduit inserted vertically in the upper wall of the inner lid; and
wherein when the pressure relief valve is in the fourth position, the valve spool disengages from the outlet so that the cavity of the inner lid is in communication with exterior atmosphere.

16. The lid assembly according to claim 12, wherein the lever comprises a first section and a second section both extending substantially in a horizontal direction, and a middle section connecting the first section and the second section and provided with a fulcrum, the first section comprising the first end of the lever, the second section comprising the second end of the lever; and
wherein the first end of the lever abuts against a lower surface of the first end of the air frying valve position limiter, and the second end of the lever abuts against a lower surface of the valve body of the pressure relief valve.

17. The lid assembly according to claim 13, wherein the lever comprises a first section and a second section both extending substantially in a horizontal direction, and a middle section connecting the first section and the second section and provided with a fulcrum, the first section comprising the first end of the lever, the second section comprising the second end of the lever; and
wherein the first end of the lever abuts against a lower surface of the second end of the C-shaped member, and the second end of the lever abuts against a lower surface of the valve body of the pressure relief valve.

18. The lid assembly as claimed in claim 16, wherein the lower surface of the second end of the C-shaped member further comprises a boss.

19. A multifunctional cooking utensil comprising a utensil body, characterized in that the cooking utensil further comprises a lid assembly of claim 1 capable of sealingly covering the utensil body, and a second heating element located inside a base of the utensil body.

20. (canceled)

21. (canceled)

22. The multifunctional cooking utensil according to claim 18, wherein in the event that the lid assembly sealingly covers the utensil body, when the cooking mode switching device is in the first state, a sealed cooking chamber is formed between the lid assembly and the utensil body, at which time food inside the cooking chamber can be pressured cooked; when the cooking mode switching device is in the second state, the cooking chamber between the lid assembly and the utensil body is in communication with exterior atmosphere, at which time food inside the cooking chamber can be baked or air fried.

23. The multifunctional cooking utensil according to claim 18, further comprising a controller, a human-machine interaction panel signally connected with the controller and having a display screen, and a sensor located in the proximity of the air frying valve position limiter and used for sensing its position;
wherein when the cooking mode switching device is in the first state, the sensor sends a first signal to the controller and the controller commands the human-machine interaction panel to display a menu prompt corresponding to a pressure cooking mode; and
wherein when the cooking mode switching device is in the second state, the sensor sends a second signal to the controller and the controller commands the human-machine interaction panel to display a menu prompt corresponding to a baking/air frying mode.
